(19) United States
(12) Patent Application Publication
(10) Pub. No.: US 2017/0327035 A1
(43) Pub. Date: Nov. 16, 2017

(54) METHODS AND SYSTEMS FOR BEYOND-THE-HORIZON THREAT INDICATION FOR VEHICLES

(71) Applicant: Ford Global Technologies, LLC, Dearborn, MI (US)

(72) Inventor: Lynn Valerie Keiser, Mountain View, CA (US)

(21) Appl. No.: 15/151,318

(22) Filed: May 10, 2016

(51) Int. Cl. B60Q 9/00; G01S 17/06; B60K 35/00; G01S 13/06; G08G 1/04; G01S 19/13

(52) U.S. Cl. CPC B60Q 9/008; G08G 1/04; G01S 19/13; B60K 35/00; G01S 13/06; G01S 17/06

(57) ABSTRACT

Methods and systems for Beyond-the-Horizon Threat Indication (BHTI) for vehicles are described. A system and a method may involve receiving motion information of a first vehicle. The system and the method may also involve receiving vicinity data corresponding to a vicinity of the first vehicle. The system and the method may also involve determining whether the first vehicle is subject to a potential hazard within the vicinity based on the motion information and the vicinity data. The system and the method may further involves alerting the first vehicle about the potential hazard in response to the determining of the potential hazard.

### TECHNICAL FIELD

The present disclosure generally relates to traffic safety and, more particularly, to methods and systems for Beyond-the-Horizon Threat Indication (BHTI) for automobile drivers.

### BACKGROUND

Various factors affect traffic safety of a transportation network which relies upon automobiles operated by individual drivers as main transportation vehicles. Of the various safety factors, some may be driver-related, while others may be vehicle-related. For example, a driver's driving habits, driving skills, physical condition, stress level, attention span, judgement of road situations, sobriety, etc., all contribute to how safely this driver may operate a vehicle. Likewise, the vehicle's condition and specification, such as maneuverability, agility, mechanical responsiveness to driver's manipulation, robustness of the breaking system, equipment of safety mirrors, head lamps and signal lights, condition of brake system, etc., also contribute to how safely the vehicle may be operated by a driver.

While the safety factors mentioned above, either driver-related or vehicle-related, may vary from driver to driver and from vehicle to vehicle, it is a general rule that the longer a response time is available to a driver regarding a traffic situation, the higher chance the driver is able to respond to the traffic situation properly, thereby ensuring traffic safety. On the contrary, when a traffic situation, e.g., a traffic hazard, emerges with a short notice to a driver and therefore allows a short response time for the driver to possibly resolve the traffic situation, there is a high chance that the driver may not be able to respond to the situation properly and safely. In such cases an accident may result.

In daily driving environment, adverse traffic situations, or driving threats, may present short notices to drivers with short response times for the drivers to react. While this is more often the case in a high-traffic, complicated and dynamic driving environment, such as at a road intersection with traffic control signals in a metropolitan area, it may also arise in a lower-traffic and relatively simple driving environment, such as on a highway in a rural area, due to specific traffic situations and road conditions. For example, a driver may have a right of way to go straight down the road and pass an intersection, without being aware of a pedestrian walking toward a crosswalk to cross the road in a perpendicular direction, as a line of sight (LoS) from the driver to the pedestrian may be blocked by a large commercial truck stopping in front of the crosswalk and awaiting the pedestrian to make the crossing. The driver may intend to pass the intersection without changing the speed of the vehicle while being unaware of the pedestrian, only to find out in a split second that the pedestrian suddenly presents in front of the vehicle as the vehicle gets very close to the crosswalk. The response time may be even shorter if the pedestrian wears clothing in a dark color and the ambient lighting is poor. As another example, a driver may be moving in an uphill direction at high speed on a highway in a rural and hilly area while being unaware of a herd of livestock wandering slowly in the driving lane just over the top of the hill, as a LoS from the driver to the herd is blocked by the hill. The driver and the vehicle may move past the hill top at high speed, only to discover the herd of livestock in front of the vehicle in a sudden, and thus the driver may be unable to react in time to avoid a collision with the herd.

### BRIEF DESCRIPTION OF THE DRAWINGS

Non-limiting and non-exhaustive embodiments of the present disclosure are described with reference to the following figures, wherein like reference numerals refer to like parts throughout the various figures unless otherwise specified.

FIG. 1 is a diagram depicting an example scenario in which embodiments in accordance with the present disclosure may be utilized.

FIG. 2 is a diagram depicting another example scenario in which embodiments in accordance with the present disclosure may be utilized.

FIG. 3 is a flowchart of an example process in accordance with an embodiment of the present disclosure.

FIG. 4 is a diagram depicting an example system in accordance with an embodiment of the present disclosure.

FIG. 5 is a diagram depicting an example architecture in accordance with an embodiment of the present disclosure.

FIG. 6 is a diagram depicting an example implementation in accordance with an embodiment of the present disclosure.

FIG. 7 is a diagram depicting another example implementation in accordance with an embodiment of the present disclosure.

FIG. 8 is a diagram depicting yet another example implementation in accordance with an embodiment of the present disclosure.

### DETAILED DESCRIPTION

In the following description, reference is made to the accompanying drawings that form a part thereof, and in which is shown by way of illustrating specific exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the scope of the present disclosure. The following detailed description is, therefore, not to be taken in a limiting sense.

The present disclosure aims to assist drivers to avoid potential traffic hazards, such as collisions with objects that may be out of sight of the drivers. This may be achieved by a BHTI service that employs methods and systems in accordance with the present disclosure which may determine one or more potential hazards or threats based on various kinds of traffic information received by, collected by or otherwise reported to the BHTI systems in a real-time fashion. The traffic information may concern a vicinity around at least one vehicle operated by a driver who subscribes to the BHTI service (hereinafter referred to as the “subscribing vehicle”). Alternatively or additionally, the traffic information may concern a vicinity around a local traffic structure, such as a road intersection, an overpass, a tunnel or a turn on the road. Once a threat is determined, the BHTI systems may notify or otherwise alert the driver of the subscribing vehicle immediately about the threat so as to provide the driver with a longer period of time to respond to the threat than without the BHTI service.

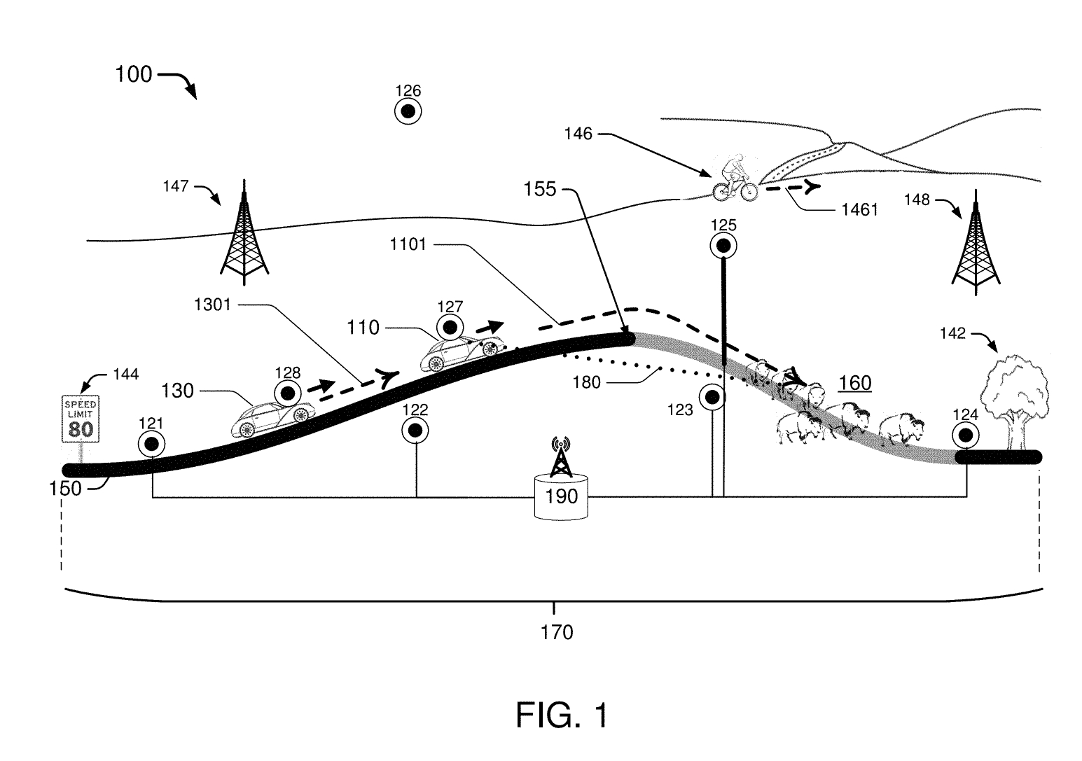

FIG. 1 depicts an example scenario 100 where a BHTI service provided by a BHTI system 190 in accordance with the present disclosure may be beneficial to subscribers of the service. Vehicles 110 and 130 may be moving at a significant speed on road 150 and approaching hilltop 155, but may be unaware of a herd of animals 160 that is wandering in road 150 on the other side of hilltop 155. Specifically, the herd of animals 160 may be out of sight of a driver of vehicle 110 because LoS 180 between vehicle 110 and the herd of animals 160 may be blocked by hilltop 155. Consequently, vehicle 110 may be in an unsafe traffic situation as animals 160 may, from the perspective of the driver of vehicle 110, suddenly show up in front of vehicle 110 as soon as vehicle 110 passes hilltop 155 and a LoS between vehicle 110 and animals 160 is established. This may result in a very short period of time for the driver of vehicle 110 to respond to the sight of animals 160 to slow down or stop vehicle 110 and avoid a collision with animals 160. Thus, a potential traffic hazard may exist between vehicle 110 and animals 160. Moreover, even if vehicle 110 may be able to slow down or even stop abruptly to avoid the collision, vehicle 130 may not be able to slow down in time to avoid colliding with vehicle 110, especially if the distance between vehicles 110 and 130 is not sufficient. This second potential traffic hazard may be more probable, especially if vehicle 110 happens to be an over-sized commercial vehicle, because a LoS from vehicle 130 to the herd of animals 160 may never be established due to blockage by vehicle 110.

BHTI system 190 may be helpful in preventing the potential traffic hazards as mentioned if either or both of the driver of vehicle 110 and the driver of vehicle 130 is/are subscribed to a BHTI service provided by BHTI system 190. BHTI system 190 may monitor a region of vicinity 170 for traffic situations, including moving and stationary objects within vicinity 170, through a distributed sensor system having a plurality of sensors disposed within vicinity 170. Vicinity 170 may be defined around a subscribing vehicle such as vehicle 110. Alternatively or additionally, vicinity 170 may be defined around a local traffic structure, such as hilltop 155. The sensors may include, for example and not limited to, one or more still cameras, one or more video cameras, and/or one or more light-detection-and-ranging (LiDAR) detectors, denoted as sensors 121, 122, 123, 124, 125, 126, 127 and 128 in FIG. 1, each of which is configured, disposed, installed or otherwise oriented to monitor a respective portion or view of vicinity 170. Sensors 121-128 may generate sensed data of vicinity 170 (collectively referred to as “vicinity data” herein) characterizing one or more moving and/or one or more stationary objects within vicinity 170. The sensors of the distributed sensor system may be disposed at various locations within vicinity 170 to achieve maximal or otherwise optimal monitoring coverage of vicinity 170. In some embodiments, sensors 121-128 may be disposed alongside road 150, such as sensors 121-124. In some embodiments, sensors 121-128 may be disposed at an elevated height, such as sensor 125, which may be located at the top of a flashing signal pole that sends a flashing signal to the traffic, and sensor 126, which may be carried by a flying drone. In some embodiments, sensors 121-128 may be carried by vehicles traveling through vicinity 170, such as sensor 127 mounted on vehicle 110 and sensor 128 mounted on vehicle 130. It is noteworthy that, although a definite quantity of sensors is shown in example scenario 100 (i.e., eight), different quantities of sensors may be utilized in various implementations in accordance with the present disclosure. It is also noteworthy that any suitable sensor other than those mentioned above may also be utilized in various implementations in accordance with the present disclosure. For example, ultrasonic sensors, infrared sensors, wireless sensors and/or other types of sensors suitable for implementations in accordance with the present disclosure may be utilized.

Each of the sensors 121-128 that is a video camera may contribute to the vicinity data by capturing in a respective video one or more moving objects within vicinity 170, such as vehicle 110, vehicle 130, animals 160 and bicycle 146. Each of the sensors 121-128 that is a video camera may also contribute to the vicinity data by capturing in the respective video one or more stationary objects within vicinity 170, such as tree 142, traffic sign 144, road 150, cell phone network base stations 147 and 148 and BHTI system 190. Each of the sensors 121-128 may feed or otherwise send the respective video and/or sensed data to BHTI system 190 for further processing and analysis. In some embodiments, some of the sensors 121-128, such as sensors 121-125, may be connected with BHTI system 190 through wires or cables, through which the videos and/or sensed data may be fed to BHTI system 190. In some embodiments, some of the sensors 121-128, such as sensors 126-128, may transmit the respective videos and/or sensed data to BHTI system 190 wirelessly.

In addition to the vicinity data (i.e., the videos and/or sensed data generated by the sensors), BHTI system 190 may also receive motion information characterizing movement of vehicles within vicinity 170. The motion information of a vehicle may include information such as location, moving direction, speed, or a combination thereof, of the vehicle. In some embodiments, BHTI system 190 may receive the motion information directly from a subscribing vehicle. For example, vehicle 110 may be a subscribing vehicle and may be equipped with a global positioning system (GPS) transceiver which constantly or otherwise periodically provide the motion information of vehicle 110 to BHTI system 190 through a wireless link established therebetween. In some embodiments, BHTI system 190 may receive the motion information from a third party. For example, the driver of vehicle 130 may carry a cell phone in vehicle 130, and a cell phone network may be able to track the cell phone and identify an instant location, a moving speed and a moving direction of the cell phone based on signals broadcasted from the cell phone to nearby cell phone network base stations 147 and 148. The cell phone network may in turn relay the motion information of the cell phone to BHTI system 190 for BHTI system 190 to characterize the movement of vehicle 130, even if vehicle 130 may not be a subscribing vehicle of the BHTI service. BHTI system 190 may utilize the motion information in estimating a respective trajectory of each vehicle in vicinity 170. For example, BHTI system 190 may utilize the motion information received directly from vehicle 110 in estimating a trajectory 1101 of vehicle 110. Likewise, BHTI system 190 may utilize the motion information of the cell phone received from the cell phone network in estimating a trajectory 1301 of vehicle 130.

BHTI system 190 may also utilize or otherwise analyze the vicinity data to estimate a trajectory of a moving object within vicinity 170. In some embodiments, BHTI system 190 may use image processing techniques to reconcile multiple views received from some or all of sensors 121-128 and calculate or otherwise project path(s) of one or more moving objects within vicinity 170. For example, BHTI system 190 may analyze the videos and estimate a trajectory 1101 of vehicle 110. Likewise, BHTI system 190 may estimate trajectories 1301 and 1461 of vehicle 130 and bicycle 146, respectively. To assist in estimating trajectories of the one or more moving objects, BHTI system 190 may be configured to identify various types of objects from the vicinity data. For example, BHTI system 190 may identify the herd of animals 160 to be a large-size, slow-moving cluster of moving objects, and estimate a trajectory (not shown in FIG. 1) of the herd of animals 160 to be random (or in a general direction) and of low speed.

Moreover, BHTI system 190 may utilize or otherwise analyze the vicinity data to identify a location of each of one or more stationary objects within vicinity 170. In some embodiments, BHTI system 190 may use image processing techniques to reconcile multiple views received from some or all of sensors 121-128 and calculate or otherwise identify location(s) of one or more stationary objects within vicinity 170. For example, BHTI system 190 may analyze the videos and identify locations of tree 142, traffic sign 144, road 150, cell phone network base stations 147 and 148 and BHTI system 190.

After analyzing the vicinity data and motion information to identify or otherwise estimate locations and trajectories of various objects within vicinity 170, BHTI system 190 may proceed to determine whether a potential traffic hazard, or threat, may exist with respect to one or more subscribing vehicles in vicinity 170 within an upcoming predetermined period of time (e.g., within the next 10 seconds, 15 seconds, 30 seconds, 1 minute or another suitable duration). Specifically, BHTI system 190 may calculate or otherwise compute to determine if any of the estimated trajectories of the one or more moving objects and the vehicles may intersect at least another one of the estimated trajectories of the one or more moving objects and the vehicles. Additionally, BHTI system 190 may calculate or otherwise compute to determine if any of the estimated trajectories of the one or more moving objects and the vehicles may intersect at least one of the identified locations of the one or more stationary objects. Moreover, BHTI system 190 may determine if a potential traffic accident may happen to one or more subscribing vehicles in vicinity 170 within an immediate “minimum response time” or a predetermined period of time of, say, 30 seconds. For example, BHTI system 190 may determine that subscribing vehicle 110 may potentially collide with the herd of animals 160 in 15 seconds if subscribing vehicle 110 proceeds along estimated trajectory 1101 at its current speed, and would result in a traffic accident or road hazard. As the duration of 15 seconds is less than the minimum response time of 30 seconds in this example, BHTI system 190 may then determine that vehicle 110 is subject to a potential hazard, or is under the threat of a collision, and may subsequently alert the driver of vehicle 110 about the threat. On the other hand, BHTI system 190 may determine that subscribing vehicle 130 is free from any potential hazard within the immediate minimum response time, and thus may determine that vehicle 130 is “safe” and does not issue an alert. In addition, BHTI system 190 may determine that bicycle 146 does not present a threat to subscribing vehicles 110 and 130, as the estimated trajectory 1461 of bicycle 146 may not intersect with either trajectory 1101 of vehicle 110 or trajectory 1301 of vehicle 130.

It is worth noting that the minimum response time may be variable or otherwise adjustable depending on factors such as road condition, weather condition, type of road, day time or night time, urban or rural area, residential or business area, speed limit of the road section and so on. The minimum response time may also be adjustable or otherwise customizable for a specific driver. For instance, BHTI system 190 may possess information that the driver of subscribing vehicle 110 is elderly or handicapped, and thus may allocate a longer minimum response time for the driver. Likewise, the minimum response time may further be adjustable or otherwise customizable for a specific type of vehicle. For instance, BHTI system 190 may possess information that subscribing vehicle 110 is an 18-wheel heavy-weight commercial truck that requires more time to slow down or to break, and thus may allocate a longer minimum response time for vehicle 110. It is also worth noting that an intersection of trajectories that is estimated to happen beyond the minimum response time may not be considered as a potential hazard, as a driver may be deemed to have sufficient time to respond to avoid the possible collision.

Upon determining a subscribing vehicle to be subject to a potential hazard, BHTI system 190 may alert the subscribing vehicle about the potential hazard in one or more of various ways. For example, BHTI system 190 may communicate to vehicle 110 wirelessly and issue an audible warning tone or even a voice warning message stating, for example, “Slow down. Animals present in front. May collide in 15 seconds.” This may be done, for example, by BHTI system 190 transmitting a wireless signal to vehicle 110 to trigger an electronic system in vehicle 110 (e.g., inside the dashboard of vehicle 110) to emit or present the audible warning. In some embodiments, BHTI system 190 may communicate to vehicle 110 wirelessly and present on a visual display, such as a liquid crystal display (LCD) of a navigation system integrated with or otherwise dashboard-mounted to vehicle 110, the spatial relationship between vehicle 110 and the threat (animals 160) as vehicle 110 approaches the herd of animals 160. Alternatively or additionally, BHTI system 190 may communicate to vehicle 110 wirelessly and present on a visual display, such as a head-up display (HUD) integrated on the windshield of vehicle 110, blinking lights and/or object outlines of the threat as vehicle 110 approaches the herd of animals 160. In some embodiments, BHTI system 190 may communicate to vehicle 110 wirelessly and alert the driver of vehicle 110 by a vibration (e.g., on the steering wheel or driver's seat) or one or more other human-perceivable indications. In some embodiments, BHTI system 190 may communicate to vehicle 110 wirelessly and send commands to remotely decelerate vehicle 110 to avoid the potential collision with the herd of animals 160. For example, BHTI system 190 may transmit a wireless signal to vehicle 110 to control a braking system on vehicle 110 to apply brakes on the wheels of vehicle 110 to assist the driver in slowing down, or even stop, vehicle 110.

In some embodiments, a vehicle may be equipped with one or more on-board proximity sensors that are configured to detect closeness or a distance between the vehicle and one or more objects that are closest to the vehicle. For example, vehicle 130 may be equipped with one or more radar transceivers or LiDAR transceivers on the front end of vehicle 130 that are able to detect a distance to the rear end of vehicle. This proximity information, i.e., the instant distance between the front end of vehicle 130 and the rear end of vehicle 110 as detected by the one or more proximity sensors, may be broadcasted or otherwise wirelessly transmitted to BHTI system 190 for determination of a potential hazard. For instance, if BHTI system 190 determines that vehicle 130 may be approaching vehicle 110 at too high a speed within the safety response time, BHTI system 190 may accordingly determine both vehicles 110 and 130 to be subject to the potential collision, and BHTI system 190 may respectively alert vehicles 110 and 130 (both being subscribing vehicles in this example) about the potential hazard, or even intervene by remotely decelerating vehicle 130 and/or remotely accelerating vehicle 110 to avoid the possible hazard and resolve the threat. For example, BHTI system 190 may transmit a wireless signal to vehicle 130 to control a braking system on vehicle 130 to apply brakes on the wheels of vehicle 130 to assist the driver in slowing down, or even stop, vehicle 130. BHTI system 190 may also transmit a wireless signal to vehicle 110 to control an acceleration system on vehicle 110 to apply more gas to the engine of vehicle 110 to assist the driver in accelerating vehicle 110.

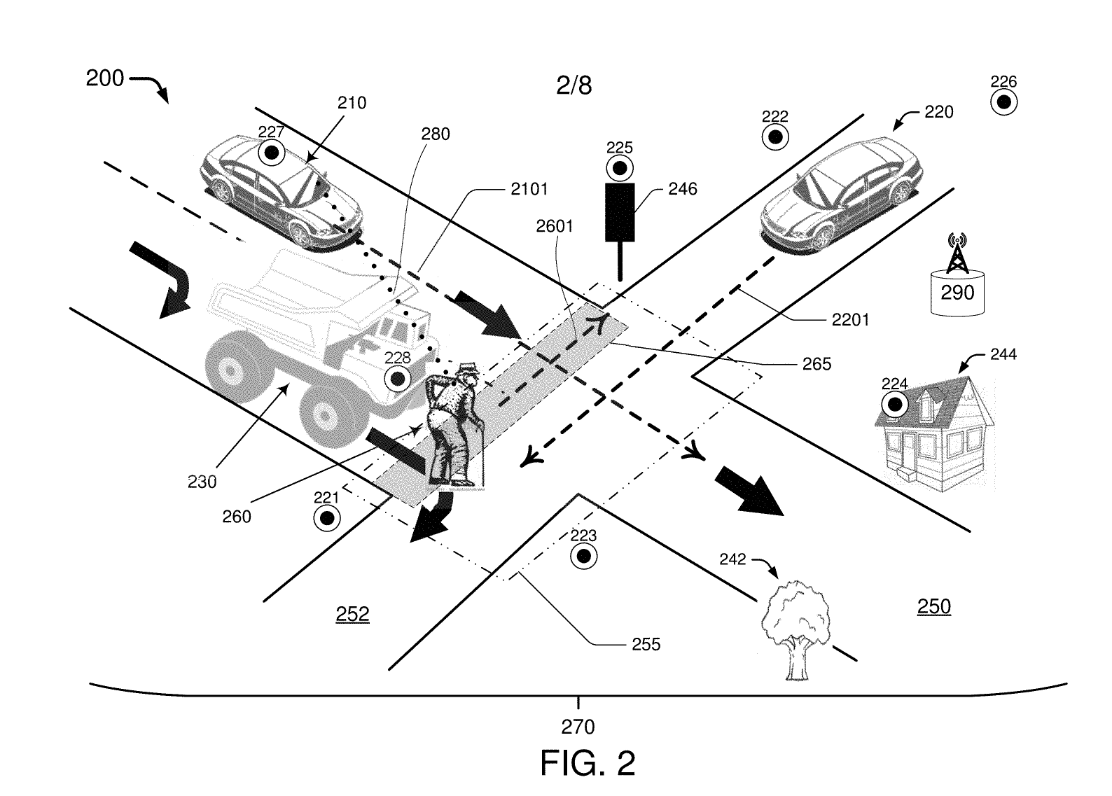

FIG. 2 depicts another example scenario 200 where a BHTI service provided by a BHTI system 290 in accordance with the present disclosure may be beneficial to subscribers of the service. Roads 250 and 252 may run substantially perpendicular to one another, forming intersection 255. Vehicle 210 may be moving down road 250, without an intention to slow down when approaching intersection 255, as vehicle 210 may have the right of way over the other direction (i.e., traffic along road 252) according to traffic light signal 246. Meanwhile, vehicle 230 may be staying on the right lane of road 250 with an intention to make a right turn onto road 252. Nevertheless, vehicle 230 may not be allowed to make the right turn at the moment and may, instead, wait in front of crosswalk 265, as pedestrian 260 has entered crosswalk 265 with an intention to cross road 250. The driver of vehicle 210, however, may not be aware of pedestrian 260 walking in crosswalk 265, because LoS 280 between vehicle 210 and pedestrian 260 may be blocked by vehicle 230. That is, pedestrian 260 may be out of sight of the driver of vehicle 210. Consequently, vehicle 210 may be in an unsafe traffic situation as pedestrian 260 may, from the perspective of the driver of vehicle 210, suddenly show up to vehicle 210 as soon as pedestrian 260 passes the front of vehicle 230 when a LoS between vehicle 210 and pedestrian 260 is established. This may allow a very short period of time for the driver of vehicle 210 to respond to the sight of pedestrian 260 to slow down vehicle 210 and avoid a collision with pedestrian 260. Thus, a potential traffic hazard may exist between vehicle 210 and pedestrian 260.

BHTI system 290 may be helpful in preventing the potential traffic hazard as mentioned if vehicle 210 is a subscriber of a BHTI service provided by BHTI system 290. BHTI system 290 may monitor a region of vicinity 270 for traffic situations, including moving and stationary objects within vicinity 270, through a distributed sensor system having a plurality of sensors disposed within vicinity 270. Vicinity 270 may be defined around a subscribing vehicle such as vehicle 210. Alternatively or additionally, vicinity 270 may be defined around a local traffic structure, such as intersection 255. The sensors may include one or more still cameras, one or more video cameras, and/or one or more LiDAR detectors, denoted as sensors 221, 222, 223, 224, 225, 226, 227 and 228 in FIG. 2, each of which configured, disposed, installed or otherwise oriented to monitor a respective portion or view of vicinity 270. Sensors 221-228 may generate sensed data of vicinity 270 (collectively referred to as “vicinity data”) characterizing one or more moving and one or more stationary objects within vicinity 270. The sensors of the distributed sensor system may be disposed at various locations within vicinity 270 to achieve maximal or otherwise optimal monitoring coverage of vicinity 270. In some embodiments, sensors 221-228 may be disposed alongside roads 250 and 252, such as sensors 221-223. In some embodiments, sensors may be disposed at an elevated height, such as sensor 224 which may be located at the top of house 244, sensor 225 which may be located at the top of a traffic light pole that gives traffic control light signal to the traffic on roads 250 and 252, and sensor 226 which may be carried by a flying drone. In some embodiments, sensors may be carried by vehicles traveling through vicinity 270, such as sensor 227 mounted on vehicle 210 and sensor 228 mounted on vehicle 230. It is noteworthy that, although a definite quantity of sensors is shown in example scenario 200 (i.e., eight), different quantities of sensors may be utilized in various implementations in accordance with the present disclosure. It is also noteworthy that any suitable sensor other than those mentioned above may also be utilized in various implementations in accordance with the present disclosure. For example, ultrasonic sensors, infrared sensors, wireless sensors and/or other types of sensors suitable for implementations in accordance with the present disclosure may be utilized.

Each of the sensors 221-228 that is a video camera may contribute to the vicinity data by capturing in a respective video one or more moving objects within vicinity 270, such as vehicle 210, vehicle 220, vehicle 230 and pedestrian 260. Each of the sensors 221-228 that is a video camera may also contribute to the vicinity data by capturing in the respective video one or more stationary objects within vicinity 270, such as tree 242, house 244, traffic light 246, roads 250 and 252 and BHTI system 290. Each of the sensors 221-228 may feed or otherwise send the respective video and/or sensed data to BHTI system 290 for further processing and analysis. Some of the sensors 221-228 may be connected with BHTI system 290 through wires or cables, through which the videos and/or sensed data may be fed to BHTI system 290, whereas some of the sensors 221-228 may transmit the respective videos and/or sensed data to BHTI system 290 wirelessly.

In addition to the vicinity data (i.e., the videos and/or sensed data generated by the sensors), BHTI system 290 may also receive motion information similar to the motion information received by BHTI system 190 from vehicles 110 and 130. Likewise, the motion information may characterize movement of vehicles within vicinity 270, and may include information such as location, moving direction, speed, or a combination thereof, of the vehicles. In some embodiments, BHTI system 290 may receive the motion information directly from a subscribing vehicle. For example, each of vehicles 210 and 230 may be a subscribing vehicle and may be equipped with a GPS transceiver which constantly or otherwise periodically provide the motion information of vehicles 210 and 230 to BHTI system 290, respectively in a wireless fashion. In some embodiments, BHTI system 290 may receive the motion information from a third party. For example, the driver of vehicle 220 may carry a cell phone or some other wireless communication device in vehicle 220, and a cell phone network may be able to track the cell phone or the wireless communication device and identify an instant location, a moving speed and a moving direction of the cell phone or the wireless communication device based on signals broadcasted from the cell phone or the wireless communication device to nearby cell phone network base stations (not shown in FIG. 2). The cell phone network may in turn relay the motion information of the cell phone or the wireless communication device to BHTI system 290 for BHTI system 290 to characterize the movement of vehicle 220. BHTI system 290 may utilize the motion information in estimating a respective trajectory of each vehicle, such as trajectory 2101 of vehicle 210 and trajectory 2201 of vehicle 220. A trajectory may not be estimated for vehicle 230, as vehicle 230 may not be moving for the moment in scenario 200.

Similar to BHTI system 190 of FIG. 1, BHTI system 290 of FIG. 2 may also utilize or otherwise analyze the vicinity data to estimate a trajectory of a moving object within vicinity 270. In some embodiments, BHTI system 290 may use image processing techniques to reconcile multiple views received from some or all of sensors 221-228 and calculate or otherwise project path(s) of one or more moving objects within vicinity 270. For example, BHTI system 290 may analyze the videos and estimate a trajectory 2101 of vehicle 210, a trajectory 2201 of vehicle 220, and a trajectory 2601 of pedestrian 260. To assist in estimating trajectories for the moving objects, BHTI system 290 may be configured to identify various types of objects from the vicinity data. For example, BHTI system 290 may identify the pedestrian 260 to be a pedestrian with a walking stick, and accordingly estimate multiple and/or fuzzy trajectories (only one of them shown in FIG. 2) of low speed for pedestrian 260, as a pedestrian's trajectory may be somewhat unpredictable. For example, pedestrian 260 may turn around in the middle of crosswalk 265 and move in a reverse direction.

Moreover, BHTI system 290 may utilize or otherwise analyze the vicinity data to identify a location of each of one or more stationary objects within vicinity 270. In some embodiments, BHTI system 290 may use image processing techniques to reconcile multiple views received from some or all of sensors 221-228 and calculate or otherwise identify location(s) of one or more stationary objects within vicinity 270. For example, BHTI system 290 may analyze the videos and identify locations tree 242, house 244, traffic light 246 and BHTI system 290.

Similar to BHTI system 190 of FIG. 1, BHTI system 290 of FIG. 2 may calculate or otherwise compute to determine if any of the estimated trajectories of the one or more moving objects and the vehicles may intersect at least another one of the estimated trajectories of the one or more moving objects and the vehicles. Additionally, BHTI system 290 may calculate or otherwise compute to determine if any of the estimated trajectories of the one or more moving objects and the vehicles may intersect at least one of the identified locations of the one or more stationary objects. Also similarly, BHTI system 290 of FIG. 2 may subsequently proceed to determine whether such a potential traffic hazard, or threat, may occur in an upcoming “minimum response time” period, which may be a predetermined safety time threshold. For scenario 200, the minimum response time may be predetermined as 10 seconds, and BHTI system 290 may determine that subscribing vehicle 210 may be subject to a potential traffic accident or road hazard, as BHTI system 290 may be determined that vehicle 210 may potentially collide with pedestrian 260 if vehicle 210 proceeds along estimated trajectory 2101 at its current speed for 5 seconds.

Similar to scenario 100 of FIG. 1, vehicles 210, 220 and 230 of FIG. 2 may be equipped with proximity sensors that generate and provide proximity information, and BHTI system 290 may utilize the proximity information from vehicles 210, 220 and 230 in the determining of a potential hazard. However, compared with scenario 100, scenario 200 may provide BHTI system 290 with one more piece of information, e.g., the right-of-way status of a vehicle, to assist in the determining of a potential hazard. For example, at any given time traffic light 246 may dictate vehicles on road 250 to have the right of way for the moment, while vehicles on road 252 may not, and vice versa. Namely, vehicle 210 may maintain its current speed and pass through intersection 255, while vehicle 220 may have to decelerate as it approaches intersection 255 without entering intersection 255. BHTI system 290 may, using the motion information and/or proximity information from vehicles 210 and 220 as well as vicinity data from sensors 221-228, compute and determine that trajectory 2201 of vehicle 220 may intersect trajectory 2101 of vehicle 210 in, say, 8 seconds. Nevertheless, BHTI system 290 may not determine that vehicle 210 is subject to a potential hazard of colliding into vehicle 220. That is, BHTI system 290 may determine that vehicle 220 does not have the right of way, as dictated by traffic light 246, and is thus expected to decelerate and stop before entering intersection 255. On the other hand, for the same situation, BHTI system 290 may determine that vehicle 220 is subject to a potential hazard of colliding into vehicle 210, and thus issue an alert to vehicle 220 to advise the driver to decelerate so that vehicle 220 may not enter intersection 255. Nevertheless, if, moments later, vehicle 220 still has not decelerated as it approaches intersection 255, BHTI system 290 may then issue an alert to vehicle 210 as well, since now vehicle 220 may not be able to decelerate fast enough to avoid entering intersection 255, and a collision between vehicles 210 and 220 at intersection 255 may become imminent and more likely.

Upon determining that a subscribing vehicle within vicinity 270 may be subject to a potential hazard, BHTI system 290 may alert the subscribing vehicle about the potential hazard in a way similar to how BHTI system 190 of FIG. 1 alerts a subscribing vehicle in scenario 100. Namely, various means such as audible tones, voice alerts, LCD and HUD displays, vibrations and one or more other human-perceivable indications may, either individually or in combination, be utilized to alert the driver about the potential hazard. Moreover, BHTI system 290 may transmit a wireless signal to a subscribing vehicle to control a braking system on the subscribing vehicle to apply brakes on the wheels of the subscribing vehicle to assist the driver in slowing down, or even stop, the subscribing vehicle. Similarly, BHTI system 290 may also transmit a wireless signal to the subscribing vehicle to control an acceleration system on the subscribing vehicle to apply more gas to the engine of the subscribing vehicle to assist the driver in accelerating the subscribing vehicle.

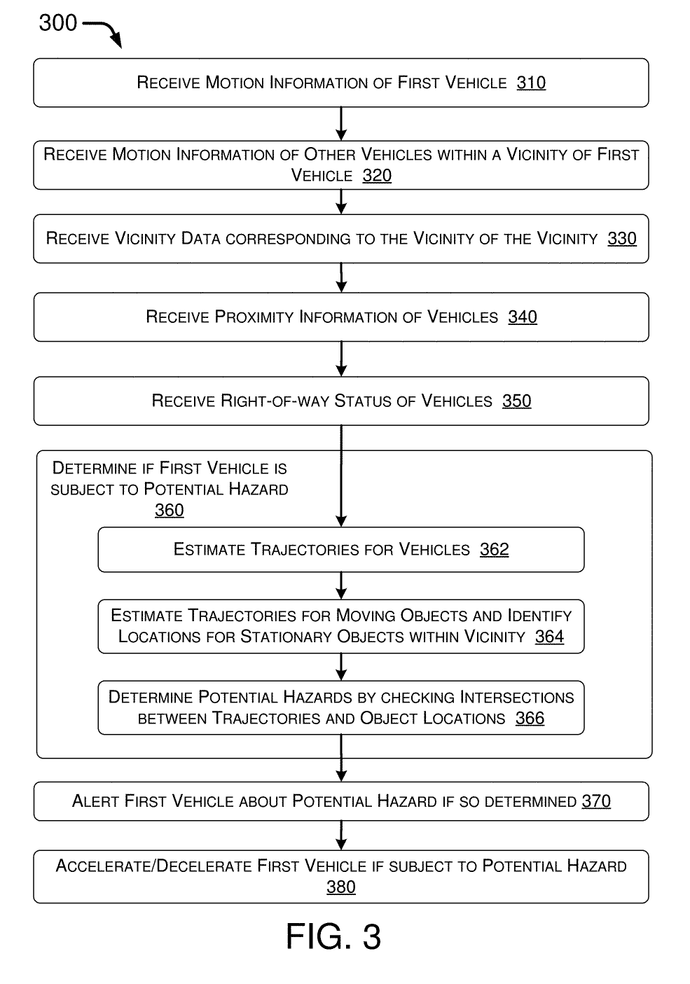

FIG. 3 illustrates an example process 300 for providing BHTI service to a transportation network in accordance with the present disclosure. Process 300 may include one or more operations, actions, or functions shown as blocks such as 310, 320, 330, 340, 350, 360, 370 and 380. Although illustrated as discrete blocks, various blocks of process 300 may be divided into additional blocks, combined into fewer blocks, or eliminated, depending on the desired implementation. Process 300 may be implemented by BHTI system 190 and BHTI system 290. Process 300 may begin with block 310.

At 310, process 300 may involve a processor receiving motion information of a first vehicle, such as vehicle 110 that subscribes or otherwise utilize the BHTI service. The motion information of the first vehicle may include information such as location, moving direction, speed, or a combination thereof, of the first vehicle. In some embodiments, the motion information may be generated by a GPS transceiver disposed in the first vehicle. In some embodiments, the motion information may be supplied by a cell phone network which tracks a communication device disposed in the first vehicle. Block 310 may be followed by block 320.

At 320, process 300 may involve the processor receiving motion information of one or more other vehicles within a vicinity of the first vehicle, such as motion information of vehicle 130 within vicinity 170 of vehicle 110. Block 320 may be followed by block 330.

At 330, process 300 may involve the processor receiving vicinity data corresponding to the vicinity of the first vehicle. The vicinity data may characterize one or more moving and stationary objects within the vicinity of the first vehicle, such as vehicle 110, vehicle 130, animals 160, bicycle 146, tree 142, traffic sign 144, road 150, cell phone network base stations 147 and 148 and BHTI system 190. The vicinity data may be generated by a distributed sensor system having one or more sensors, such as sensors 121-128. Block 330 may be followed by block 340.

At 340, process 300 may involve the processor receiving proximity information from one or more vehicles within the vicinity of the first vehicle. For example, the proximity information may be associated with closeness (e.g., a mutual distance) between the vehicle and the objects that are closest to the vehicle, such as the distance between vehicle 130 and vehicle 110. The proximity information may be generated by one or more radar transceivers or LiDAR transceivers equipped on vehicle 130. Block 340 may be followed by block 350.

At 350, process 300 may involve the processor receiving a right-of-way status for one or more vehicles within the vicinity (such as vehicles 210 and 220) from one or more traffic control structures within the vicinity (such as traffic light 246). The right-of-way status indicates whether a respective vehicle has a right of way. For example, traffic light 246 may indicate vehicle 210 has the right of way while vehicle 220 has not. Block 350 may be followed by block 360.

At 360, process 300 may involve the processor determining whether the first vehicle is subject to a potential traffic hazard within a predetermined of time. For example, BHTI system 190 may determine that vehicle 110 is subject to a potential collision with the herd of animals 160. Block 360 may involve operations performed at sub-blocks 362, 364 and 366. At 362, process 300 may involve the processor estimating trajectories of vehicles within the vicinity, such as trajectory 1101 of vehicle 110 and trajectory 1201 of vehicle 120. Sub-block 362 may be followed by sub-block 364. At 364, process 300 may involve the processor estimating trajectories of moving objects (such as trajectory 1461 of bicycle 146 and trajectory 2601 of pedestrian 260) within the vicinity and identifying locations of stationary objects (such as cell phone network base stations 147 and 148) within the vicinity. Sub-block 364 may be followed by sub-block 366. At 366, process 300 may involve the processor determining whether a subscribing vehicle (such as vehicle 210) is subjected to a potential hazard (such as potential collision with pedestrian 260) by checking whether the trajectory of the subscribing vehicle (such as trajectory 2101 of vehicle 210) intersects a trajectory of another vehicle or moving object (such as trajectory 2601 of pedestrian 260) within the vicinity. At 366, process 300 may also involve the processor determining whether a subscribing vehicle is subjected to a potential hazard by checking whether the trajectory of the subscribing vehicle intersects a location of a stationary object within the vicinity. Block 360 may be followed by block 370.

At 370, process 300 may involve the processor issuing alerts to notify the driver of the first vehicle about the potential hazard. For example, BHTI system 290 may alert the driver of vehicle 210 about potential hazard of colliding with pedestrian 260. Various means such as audible tones, voice alerts, LCD and HUD displays, vibrations and other human-perceivable indications may be utilized to alert the driver about the potential hazard. Block 370 may be followed by block 380.

At 380, process 300 may involve the processor sending commands to the first vehicle to remotely accelerate or decelerate the first vehicle and avoid the potential hazard. For example, BHTI system 290 may remotely decelerate vehicle 210 to avoid colliding into pedestrian 260 who is walking in crosswalk 265. Process 300 may end at block 380.

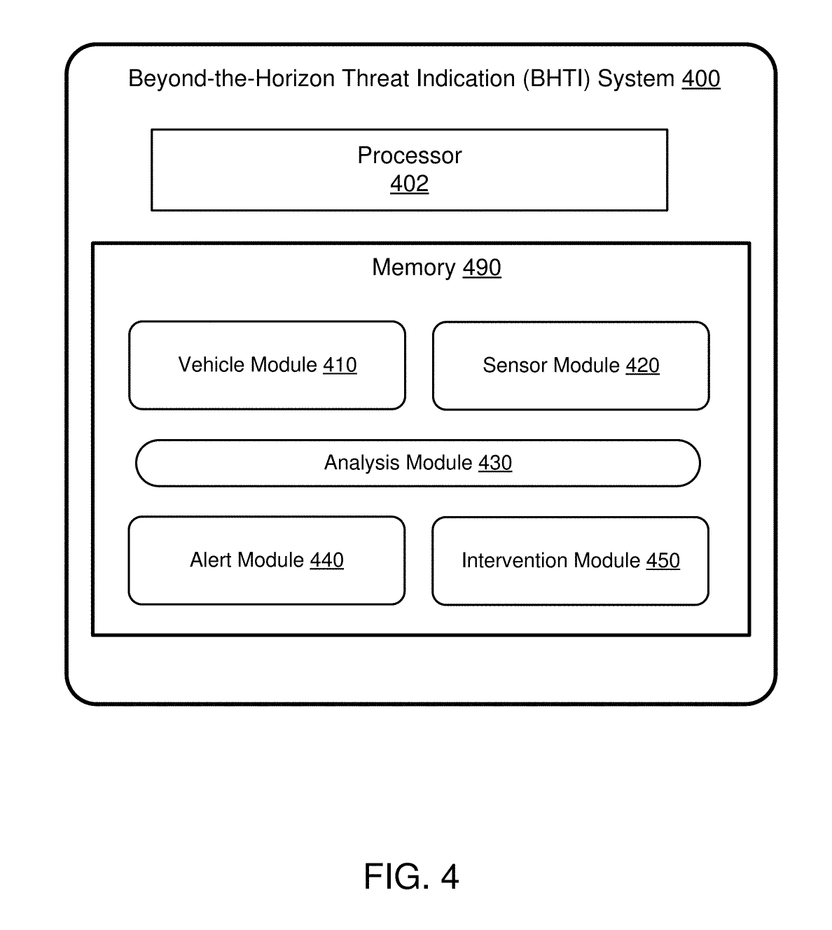

FIG. 4 illustrates an example BHTI system 400 in which example embodiments of the present disclosure may be implemented. BHTI system 400 may detect a potential traffic hazard, and alert a driver about the potential hazard while the potential traffic may still be out of sight of the driver. BHTI system 400 may achieve this purpose with any suitable method, including example process 300. BHTI system 400 may be a computing apparatus such as, for example and not limited to, a laptop computer, a tablet computer, a notebook computer, a desktop computer, a server, a smartphone and a wearable device. BHTI system 400 may be an example implementation of BHTI system 190 and/or BHTI system 290.

In some embodiments, BHTI system 400 may include one or more processors 402 and memory 490. Memory 490 may be operably connected to or otherwise accessible by the one or more processors 402, and may be configured to store one or more computer software components for execution by the one or more processors 402.

In some embodiments, memory 490 may store data, codes and/or instructions pertaining to or otherwise defining one or more components shown in FIG. 4 such as, for example, vehicle module 410, sensor module 420, analysis module 430, alert module 440 and intervention module 450.

In some embodiments, vehicle module 410 may be utilized to cause the one or more processors 402 to receive motion information of one or more vehicles within a vicinity of the traffic control structure. For example, in the context of scenario 200 as depicted in FIG. 2, vehicle module 410 may receive motion information, such as location, moving direction, speed, or a combination thereof, of vehicles 210, 220 and 230. In some embodiments, vehicle module 410 may also be utilized to cause the one or more processors 402 to receive proximity information from one or more vehicles within a vicinity of the traffic control structure. The proximity information may be associated with closeness (e.g., a mutual distance) between the vehicle and the objects that are closest to the vehicle, such as the distance between vehicle 210 and vehicle 230. The proximity information may be generated by one or more radar transceivers or LiDAR transceivers equipped on vehicle 210. In some embodiments, vehicle module 410 may further be utilized to cause the one or more processors 402 to receive from a traffic control structure a right-of-way status for one or more vehicles within the vicinity. The right-of-way status may indicate whether a vehicles has a right of way. For example, BHTI system 290 may receive a right-of-way status for vehicle 210 indicating that vehicle 210 has the right of way. Meanwhile, BHTI system 290 may receive a right-of-way status for vehicle 220 indicating that vehicle 220 does not have the right of way.

In some embodiments, sensor module 420 may be utilized to cause the one or more processors 402 to receive vicinity data generated by one or more sensors disposed within the vicinity of the traffic control structure. For example, BHTI system 290 may receive vicinity data as presented in a number of videos generated by cameras 221-228 that are disposed at various locations within vicinity 270 of traffic light 246. The vicinity data may correspond to one or more moving objects (such as vehicle 210, vehicle 220, vehicle 230 and pedestrian 260) and one or more stationary objects (such as tree 242, house 244, traffic light 246, roads 250 and 252 and BHTI system 290) that are located within vicinity 270.

In some embodiments, analysis module 430 may be utilized to cause the one or more processors 402 to determine whether a vehicle within the vicinity of the traffic control structure may be subject to a potential hazard of colliding with another vehicle, or with a moving objects or even a stationary object. For example, BHTI system 290 may determine that vehicle 210 may potentially collide with pedestrian 260. More specifically, analysis module 430 may be utilized to cause the one or more processors 402 to estimate a respective trajectory of each of the subscribing vehicles based on the motion information. In addition, analysis module 430 may be utilized to cause the one or more processors 402 to analyze the vicinity data so as to estimate a respective trajectory of each moving object and to identify a respective location of each stationary object. For example, BHTI system 290 may estimate trajectory 2101 of vehicle 210 and trajectory 2201 of vehicle 220 based on the motion information of vehicle 210 and vehicle 220. BHTI system 290 may also analyze the video feeds from cameras 221-228 to estimate trajectory 2601 of pedestrian 260, and to identify respective locations of stationary objects such as tree 242, house 244, traffic light 246, roads 250 and 252 and BHTI system 290.

In some embodiments, alert module 440 may be utilized to cause the one or more processors 402 to alert a vehicle in response to the determining of a potential hazard for the vehicle. For example, BHTI system 290 may alert vehicle 210 regarding the potential hazard of colliding into pedestrian 260. Alert module 440 may cause processors 402 to use one or more of various means to alert the driver about the potential hazard, such as audible tones, voice alerts, visual indications on LCD and HUD displays, vibrations and other human-perceivable indications. For example, BHTI system 290 may alert the driver of vehicle 210 by issuing a voice alert stating “Stop before crosswalk. Pedestrian crossing the street.” through a wireless link to vehicle 210. BHTI system 290 may simultaneously show a blinking red dot representing the threat (i.e., pedestrian 260 who is crossing road 250) on the map of a navigation system equipped in vehicle 210. As another example, when the right of way of intersection 255 is given by traffic light 246 BHTI to the traffic on road 250 rather than to the traffic on road 252, system 290 may alert the driver of vehicle 220 by issuing a voice alert stating “Slow down. Red light ahead.” through a wireless link to vehicle 220. BHTI system 290 may simultaneously vibrate the driver's seat of vehicle 220 to alert the driver of vehicle 220 about a possible hazard of colliding with vehicle 210 if vehicle 210 enters intersection 255.

In some embodiments, intervention module 450 may be utilized to cause the one or more processors 402 to remotely accelerate or decelerate a vehicle in response to the determining of the potential hazard for the vehicle. For example, when the right of way of intersection 255 is given by traffic light 246 BHTI to the traffic on road 250 rather than to the traffic on road 252, BHTI system 290 may send commands wirelessly to vehicle 220 and decelerate vehicle 220 as vehicle 220 approaches intersection 255 such that vehicle 220 does not enter intersection 255.

BHTI system 400 may be able to prevent possible traffic accidents in situations where a driving judgement may be difficult solely depending on driver's senses. For example, it may be difficult for a driver to judge how much margin he or she has when attempting to enter a road of high-speed and dynamic traffic, especially in the night time when all can be seen from the upcoming traffic is the light from headlamps. As another example, when driving on a winding road running through hills at night time, it may be difficult for a driver to judge how much he or she needs to move the driving wheel to make each turn. BHTI system 400 may be able to alert the driver about possible hazards in difficult driving situations like these, thereby reducing the probability of having an accident.

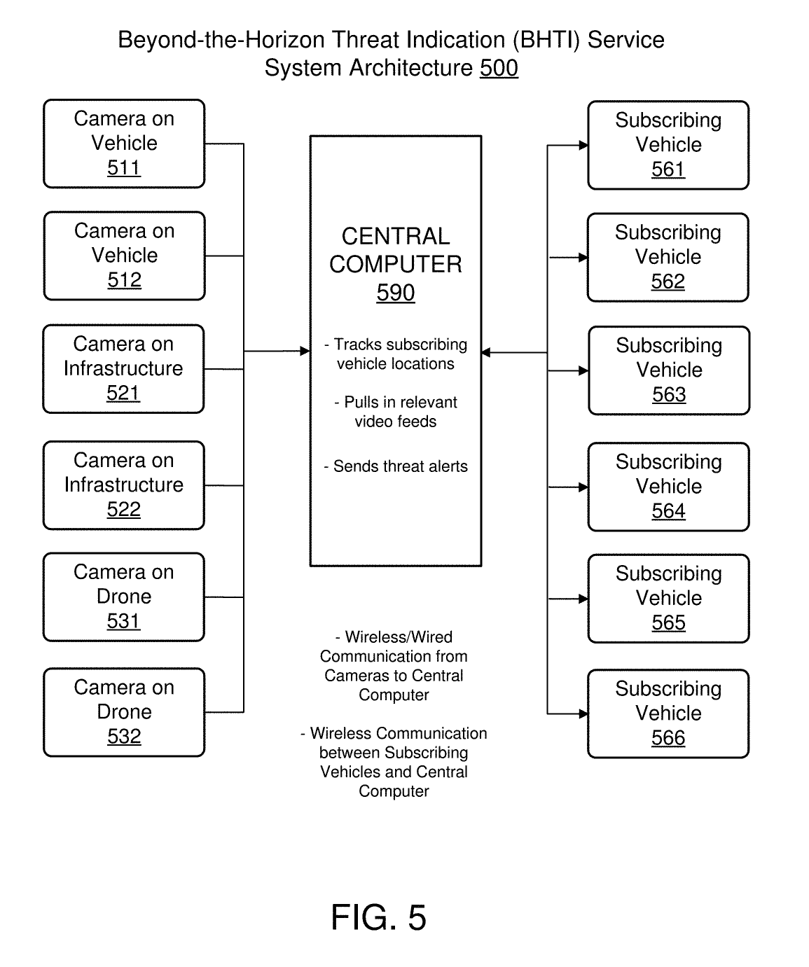

FIG. 5 depicts an example system architecture 500 for a BHTI service, which may be implemented for scenario 100 of FIG. 1 and scenario 200 of FIG. 2. Architecture 500 may have central computer 590. Architecture 500 may also have one or more sensors that may be connected to central computer 590 either through wires or wirelessly. Solely for illustrative purpose the one or more sensors are shows as a number of cameras in architecture 500, such as cameras 511, 512, 521, 522, 531 and 532, although sensors other than cameras are also within the scope of the present disclosure. The cameras may be mounted or otherwise disposed at various physical locations within an area where the BHTI service intends to cover. For example, one or more of the cameras, such as cameras 511 and 512, may be mounted on vehicles within the area, while one or more of the cameras, such as cameras 521 and 522, may be mounted on or along infrastructures such as traffic lights, bridges, highway entrance, roads, and so on. Some cameras, such as cameras 531 and 532, may even be carried by flying drones and stay hovering above the area. Within the area there may be one or more subscribing vehicles, such as vehicles 561-566, each having a two-way wireless communication link to central computer 590. Central computer 590 may track one or more of subscribing vehicles 561-566 by their respective locations in the area. In addition to tracking one or more of subscribing vehicles 561-566, central computer 590 may pull in video feeds from cameras that are located near a vicinity around one or more of subscribing vehicles 561-566 (i.e., the relevant video feeds of the one or more of subscribing vehicles 561-566). Central computer 590 may determine whether one or more of subscribing vehicles 561-566 may be subject to a potential traffic hazard based on the relevant video feeds. Upon determining that one of subscribing vehicle 561-566 is subject to a potential traffic hazard, central computer 590 may alert the subscribing vehicle about the potential hazard via one or more human-perceivable indications as previously discussed.

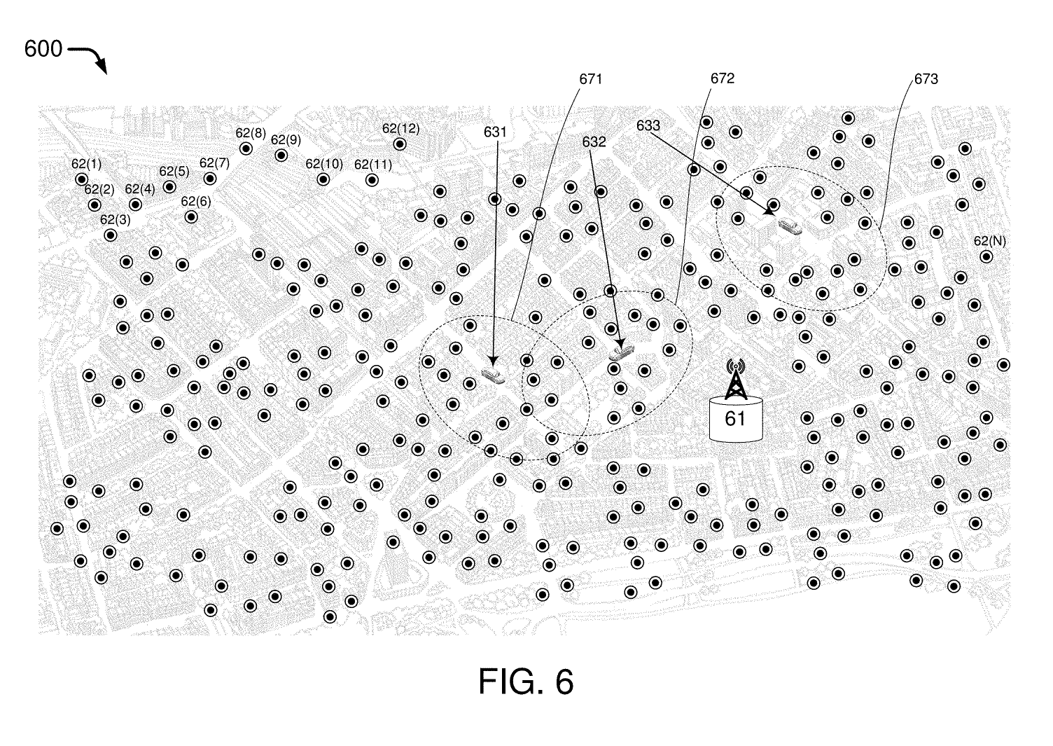

FIG. 6 depicts an example system implementation 600 for a BHTI service. In implementation 600, a plurality of sensors, such as 62(1), 62(2), . . . , 62(N) (with N being a positive integer greater than or equal to 1), may be disposed at various locations of a geographic region (e.g., a city or a metropolitan area, or a district thereof) as shown in FIG. 6. The sensors 62(1)-62(N) may be stationary or mobile, and may be of various types of cameras or any other suitable forms of sensors as mentioned previously. The sensors 62(1)-62(N) may be wired to a central computer, i.e., BHTI system 61 and/or connected to BHTI system 61 wirelessly. One or more subscribing vehicles, such as vehicles 631, 632 and 633, may be moving around respective parts of the geographic region. BHTI system 61 may define for each subscribing vehicle a respective vicinity, such as vicinity 671 for vehicle 631, vicinity 672 for vehicle 632 and vicinity 673 for vehicle 633, based on an immediate location of each of the subscribing vehicles 631, 632 and 633. BHTI system 61 may analyze videos from one or more cameras within a particular vicinity to determine if a respective vehicle (e.g., subscribing vehicle 631, 632 or 633) may be subject to a potential hazard. BHTI system 61 may subsequently alert the respective vehicle about the potential hazard so that the driver of that vehicle may take proper measures to respond to the potential hazard. For example, BHTI system 61 may analyze videos from one or more cameras within vicinity 671 and determine that vehicle 631 may be subject to a potential hazard. Accordingly, BHTI system 61 may subsequently alert vehicle 631 about the potential hazard so that the driver of vehicle 631 may take proper measures to respond to the potential hazard.

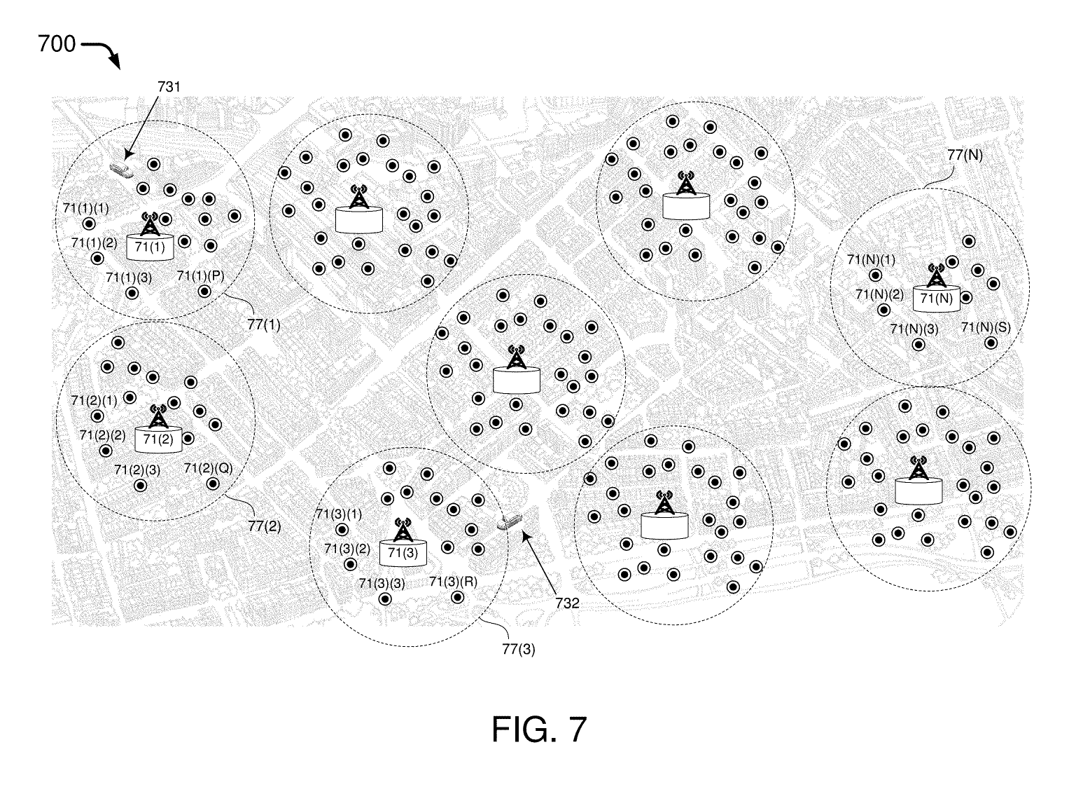

FIG. 7 depicts another example system implementation 700 for a BHTI service. As opposed to serving all subscribing vehicle with a central computer 61, implementation 700 takes a distributed system approach and reply on a plurality of local BHTI systems 71(1), 71(2), . . . 71(N) (with N being a positive integer greater than or equal to 1) to collectively serve a part of a geographic region (e.g., a city or a metropolitan area), such as a district or one or more city blocks. In this approach, each of local BHTI systems 71(1)-71(N) may serve a respective vicinity, and may be disposed near a traffic control structure such as an intersection or a railroad crossing. In addition, each of local BHTI systems 71(1)-71(N) may be built at a lower cost and may consume less power than a single central server such as BHTI system 61 of implementation 600. Each of local BHTI systems 71(1)-71(N) may have one or more sensors disposed within the respective vicinity. For example, BHTI system 71(1) may have P number of cameras 71(1)(1)-71(1)(P) disposed at various locations within vicinity 77(1), with P being a positive integer greater than or equal to 1. Similarly, BHTI system 71(2) may have Q number of cameras 71(2)(1)-71(2)(Q) disposed at various locations within vicinity 77(2), with Q being a positive integer greater than or equal to 1. Additionally, BHTI system 71(3) may have R number of cameras 71(3)(1)-71(3)(R) disposed at various locations within vicinity 77(3), with R being a positive integer greater than or equal to 1. Likewise, BHTI system 71(N) may have S number of cameras 71(N)(1)-71(N)(S) disposed at various locations within vicinity 77(N), with S being a positive integer greater than or equal to 1. A subscribing vehicle may be served by one or more of local BHTI systems 71(1)-71(N). For example, vehicle 731 may be currently moving within vicinity 77(1), and thus may be served by BHTI system 71(1). Likewise, vehicle 732 may enter vicinity 77(3) and thus may be served by BHTI system 71(3).

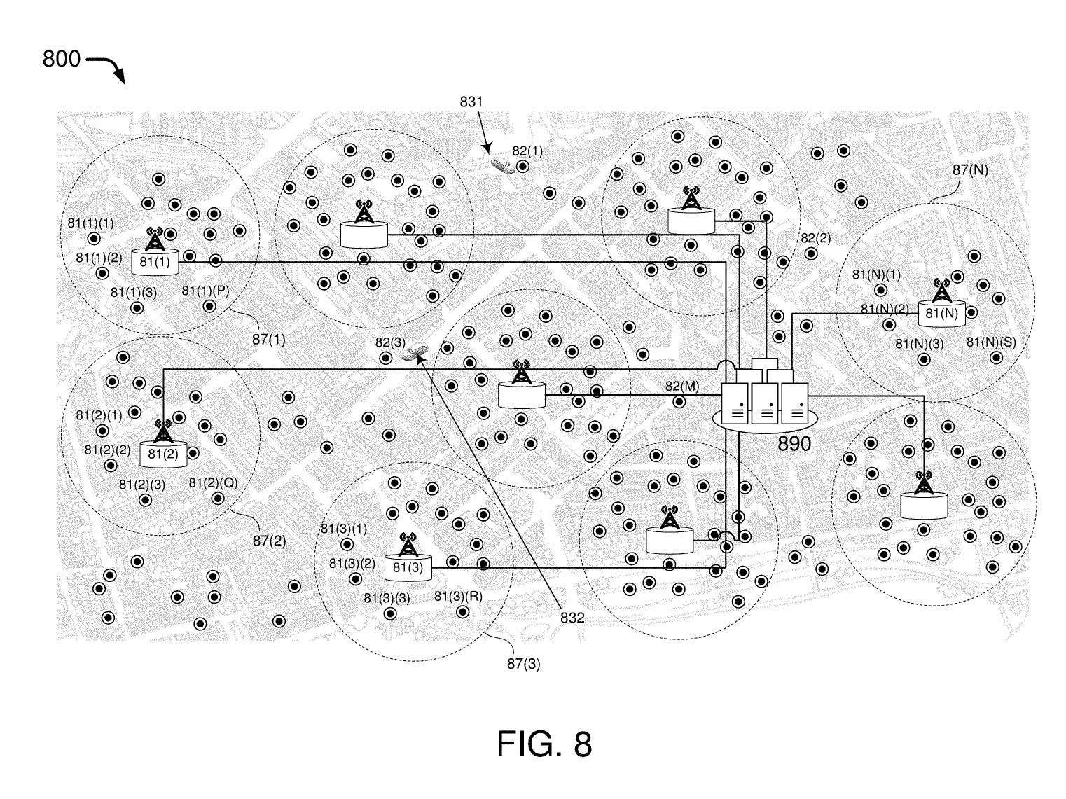

FIG. 8 depicts yet another example system implementation 800 for a BHTI service. Compared with implementation 700 of FIG. 7, BHTI implementation 800 may further include a central BHTI server 890 and a number of local BHTI servers 81(1)-81(N) with N being a positive integer greater than or equal to 1, where central BHTI server 890 may serve areas that are not covered by any of local BHTI servers 81(1)-81(N). For example, a plurality of sensors, such as cameras 82(1)-82(M) for example (with M being a positive integer greater than or equal to 1), may not be located within any of vicinities 87(1)-87(N), and thus none of the local BHTI servers 81(1)-81(N) would request a video feed from any of cameras 82(1)-82(M). Cameras 82(1)-82(M) may instead be configured to communicate to BHTI server 890 so that the BHTI service may be provided to a subscribing vehicle, such as vehicles 831 and/or 832, that may not be immediately driving within a vicinity of any of the local BHTI servers 81(1)-81(N).

The present disclosure greatly improves traffic safety by alerting drivers of potential traffic hazards, or driving threats, within the vicinity that may be currently out of sight of the drivers. Methods and systems according to the present disclosure may greatly enhance a driver's knowledge of the traffic situation beyond the immediate vicinity where driver's senses can reach. Accordingly, many practical driving situations that are prone to accidents may be effectively prevented.

The articles “a” and “an” are used herein to refer to one or to more than one (i.e., to at least one) of the grammatical object of the article. By way of example, “a user” means one user or more than one users. Reference throughout this specification to “one embodiment,” “an embodiment,” “one example,” or “an example” means that a particular feature, structure, or characteristic described in connection with the embodiment or example is included in at least one embodiment of the present disclosure. Thus, appearances of the phrases “in one embodiment,” “in an embodiment,” “one example,” or “an example” in various places throughout this specification are not necessarily all referring to the same embodiment or example. Furthermore, the particular features, structures, databases, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

Embodiments in accordance with the present disclosure may be embodied as an apparatus, method, or computer program product. Accordingly, the present disclosure may take the form of an entirely hardware-comprised embodiment, an entirely software-comprised embodiment (including firmware, resident software, micro-code or the like), or an embodiment combining software and hardware aspects that may all generally be referred to herein as a “circuit,” “module,” or “system.” Furthermore, embodiments of the present disclosure may take the form of a computer program product embodied in any tangible medium of expression having computer-usable program code embodied in the medium.

The flow diagrams and block diagrams in the attached figures illustrate the architecture, functionality, and operation of possible implementations of systems, methods, and computer program products according to various embodiments of the present disclosure. In this regard, each block in the flow diagrams or block diagrams may represent a module, segment, or portion of code, which comprises one or more executable instructions for implementing the specified logical function(s). It will also be noted that each block of the block diagrams and/or flow diagrams, and combinations of blocks in the block diagrams and/or flow diagrams, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flow diagram and/or block diagram block or blocks.

Although the present disclosure is described in terms of certain embodiments, other embodiments will be apparent to those of ordinary skill in the art, given the benefit of this disclosure, including embodiments that do not provide all of the benefits and features set forth herein, which are also within the scope of this disclosure. It is to be understood that other embodiments may be utilized, without departing from the scope of the present disclosure.

What is claimed is:

1. A method, comprising:
receiving, by a processor of a Beyond the Horizon Threat Indication (BHTI) system implemented in a roadside traffic control structure, motion information of a first vehicle;
receiving, by the processor from a plurality of sensors of the BHTI system that are disposed in and associated with a geographic region, vicinity data corresponding to a vicinity of the first vehicle in the geographic region;
determining, by the processor, whether the first vehicle is subject to a potential hazard, which is within the vicinity and out of a line of sight of the first vehicle, based on the motion information and the vicinity data; and
alerting, by the processor, the first vehicle about the potential hazard in response to the determining of the potential hazard.

2. The method of claim 1, wherein the motion information of the first vehicle comprises a location, a moving direction, a speed, or a combination thereof, of the first vehicle.

3. The method of claim 2, wherein the receiving of the motion information of the first vehicle comprises receiving the motion information from a global positioning system (GPS) transceiver disposed in the first vehicle, from a cell phone network tracking a communication device disposed in the first vehicle, or a combination thereof.

4. The method of claim 1, wherein the receiving of the vicinity data comprises receiving the vicinity data from one or more sensors disposed within the vicinity of the first vehicle, wherein the one or more sensors comprise one or more cameras, and wherein the vicinity data comprises one or more videos, each of the one or more videos corresponding to a respective view of the vicinity and indicating one or more moving objects and one or more stationary objects located within the respective view of the vicinity.

5. The method of claim 4, wherein the determining of the potential hazard comprises:
estimating a first trajectory of the first vehicle based on the motion information of the first vehicle;
analyzing the one or more videos to estimate one or more second trajectories each being a respective trajectory of each of the one or more moving objects;
analyzing the one or more videos to identify a respective location of each of the one or more stationary objects;
determining that the first vehicle is subject to the potential hazard in response to the first trajectory intersecting at least one of the one or more second trajectories within a predetermined period of time; and
determining that the first vehicle is subject to the potential hazard in response to the first trajectory intersecting at least one of the locations of the one or more stationary objects within the predetermined period of time.

6. The method of claim 4, wherein the one or more cameras comprise at least one camera mounted on the first vehicle, on one or more other vehicles within the vicinity, on one or more traffic control structures within the vicinity, or by or near one or more roads within the vicinity.

7. The method of claim 1, further comprising:
receiving, by the processor, motion information of one or more other vehicles within the vicinity,
wherein the determining of the potential hazard comprises determining the potential hazard based on the vicinity data and the motion information of the first vehicle and the motion information of the one or more other vehicles.

8. The method of claim 1, further comprising:
receiving, by the processor, first proximity information of the first vehicle; and
receiving, by the processor, second proximity information of one or more other vehicles within the vicinity,
wherein the determining of the potential hazard comprises determining the potential hazard based on the first proximity information and the second proximity information.

9. The method of claim 8, wherein the receiving of the first proximity information or the receiving of the second proximity information comprises receiving the first proximity information or the second proximity information from one or more radar transceivers or light-detection-and-ranging (LiDAR) transceivers disposed in the first vehicle, at least one of the one or more other vehicles, or a combination thereof, and wherein each of the first proximity information and the second proximity information represents a relative distance from the first vehicle to one or more objects in the vicinity and a relative distance from the one or more other vehicles to the one or more other objects in the vicinity, respectively.

10. The method of claim 1, further comprising:
receiving, by the processor, a right-of-way status of the first vehicle, the right-of-way status of the first vehicle indicating whether the first vehicle has a right of way; and
receiving, by the processor, a right-of-way status of at least one other vehicle within the vicinity, the right-of-way status of the least one other vehicle indicating whether the least one other vehicle has a right of way,
wherein the determining of the potential hazard is further based on the right-of-way status of the first vehicle and the right-of-way status of each of the one or more other vehicles.

11. The method of claim 10, wherein the receiving of the right-of-way status of the first vehicle and the right-of-way status of the at least one other vehicle comprises receiving the right-of-way status of the first vehicle and the right-of-way status of the at least one other vehicle from one or more traffic control structures within the vicinity.

12. The method of claim 1, wherein the alerting of the first vehicle about the potential hazard comprises notifying a driver of the first vehicle about the potential hazard with a visual display, a head-up display (HUD), a warning tone, a voice alert, a vibration, another human-perceivable indication, or a combination thereof.

13. The method of claim 1, further comprising:
sending, by the processor, one or more commands to remotely accelerate or decelerate the first vehicle in response to the determining of the potential hazard.

14. A Beyond the Horizon Threat Indication (BHTI) system implementable to a traffic control structure, comprising:
one or more sensors disposed in and associated with a geographic region;
one or more processors communicatively coupled to the one or more sensors; and
memory operably connected to the one or more processors, the memory storing a plurality of components executable by the one or more processors, the plurality of components comprising:
a vehicle module programmed to cause the one or more processors to receive motion information of one or more vehicles within a vicinity of the traffic control structure;
a sensor module programmed to cause the one or more processors to receive vicinity data generated by the one or more sensors disposed within the vicinity of the traffic control structure in the geographic region, the vicinity data corresponding to one or more moving objects and one or more stationary objects located within the vicinity;
an analysis module programmed to cause the one or more processors to determine whether a first vehicle of the one or more vehicles is subject to a potential hazard, which is out of a line of sight of the first vehicle, of colliding with a second vehicle of the one or more vehicles or at least one of the one or more moving objects and one or more stationary objects; and
an alert module programmed to cause the one or more processors to alert the first vehicle of the potential hazard.

15. The system of claim 14, wherein the one or more sensors comprise one or more cameras, and wherein the vicinity data comprises one or more videos, each of the one or more videos corresponding to a respective view of at least one of the one or more moving objects and one or more stationary objects.

16. The system of claim 15, wherein, in determining the potential hazard, the one or more processors are configured to perform acts comprising:
estimating a respective trajectory of each of the one or more vehicles based on the motion information;
analyzing the one or more videos to estimate a respective trajectory of each of the one or more moving objects;
analyzing the one or more videos to identify a location of each of the one or more stationary objects;
determining that the first vehicle is subject to the potential hazard in response to a first trajectory of the first vehicle intersecting a second trajectory of the second vehicle or a trajectory of at least one of the one or more moving objects within a predetermined period of time; and
determining that the first vehicle is subject to the potential hazard in response to the first trajectory of the first vehicle intersecting at least one of the locations of the one or more stationary objects within the predetermined period of time.

17. The system of claim 14, wherein the vehicle module is further programmed to cause the one or more processors to receive proximity information from at least one of the one or more vehicles, the proximity information representing a spatial relation between the at least one of the one or more vehicles and one or more other objects in the vicinity.

18. The system of claim 14, wherein the vehicle module is further programmed to cause the one or more processors to receive from the traffic control structure a right-of-way status for at least one of the one or more vehicles, the right-of-way status indicating whether the at least one of the one or more vehicles has a right of way.

19. The system of claim 14, wherein, in alerting first vehicle of the potential hazard, the one or more processors are configured to notify a driver of the first vehicle about the potential hazard with a visual display, a head-up display (HUD), a warning tone, a voice alert, a vibration, another human-perceivable indication, or a combination thereof.

20. The system of claim 14, wherein the plurality of components further comprising:
an intervention module programmed to cause the one or more processors to remotely accelerate or decelerate the first vehicle in response to the determining of the potential hazard.
